(19) United States
(12) Patent Application Publication
(10) Pub. No.: US 2018/0068470 A1
(43) Pub. Date: Mar. 8, 2018

(54) Treemap Visualization System and Method for Visualizing Variable Adjustments to Represented Criteria in Real Time

(71) Applicant: SPAWAR Systems Center Pacific, San Diego, CA (US)

(72) Inventor: Bryan L. Croft, San Diego, CA (US)

(73) Assignee: United States of America as represented by Secretary of the Navy, San Diego, CA (US)

(21) Appl. No.: 15/258,319

(22) Filed: Sep. 7, 2016

(51) Int. Cl. G06T 11/20; G06F 17/30; G06F 3/0482

(52) U.S. Cl. CPC G06T 11/206; G06F 3/0486; G06F 3/0482; G06F 17/30572

(57) ABSTRACT

A treemap visualization system and method which provides for real time visualization of variable adjustments to represented criteria in a treemap. The treemap visualization system and method is implemented on a computer system and employs a database having a plurality of data items to be visualized. A treemap visualization layout may be formulated with tiles based on data elements for each data item. A variable modifier module enables the adjustment of weighting of the data elements for each data item when the treemap visualization layout is formulated. Data items are sorted into discrete levels so that a plurality of stackable tile layers can be formulated. Alerts are generated when layout events are related to the physical properties or positioning of the tiles in the treemap visualization layout.

### STATEMENT OF GOVERNMENT INTEREST FEDERALLY SPONSORED RESEARCH OR DEVELOPMENT

The United States Government has ownership rights in this invention. Licensing inquiries may be directed to the Office of Research and Technical Applications, Space and Naval Warfare Systems Center, Pacific, Code 72120, San Diego, Calif. 92152; telephone (619) 553-5118; email: ssc_pac_t2@navy.mil. Reference Case No. 102,306.

### BACKGROUND OF THE INVENTION

### Field of the Invention

This invention relates generally to treemap visualization techniques for data values.

### Description of the Prior Art

There are many well-known techniques for organizing and displaying data in a hierarchal form. For example, treemapping is well established as a method for displaying hierarchical data by using nested shapes, such as rectangles. Treemap visualizations and algorithms on which such visualizations were based, were generally related to area-based visualizations of Mosaic diagrams which use rectangular tiles to show the distributions of data, became popular around the early 1990s. Advantageously, treemaps extended preceding visualization techniques by introducing user based interactive techniques which allow the display to be filtered and/or adjusted.

As a main purpose of a treemap was to display hierarchical data as a set of nested shapes, the concept of treemap visualization enabled a view of underlying data, represented by leaf nodes, that efficiently used display space and allowed a user to visually categorize the data in that display space through the color, size and location of the nodes.

Typically, color was used as a means to categorize the data into groupings or types of data. In this regard, treemaps may provide the coloring in local subsets of the display space or dispersed among all the local subsets. A treemap may or may not contain local subsets for more precise groupings of data. When local subsets of the data exist, they may allow the use of colors for other categorizations of the data. More recent versions of treemaps have included color shading to provide additional information to the treemap display. A common concept is to shade the color of a given data item darker as time progresses, thereby providing a clue as to the age of the data item. This same concept has been extended to allow such shading to represent other indications of changes in the data.

With many treemap visualizations, the size of a node's geometric region in a given display space is used to reflect some quality of the data item to which it corresponds. This quality is generally represented as the importance or some other specified criteria in the context of the universe represented by the given display space. In typical implementation, this allows a user to quickly visualize the data represented by a node both categorically based on a node's color and by importance based upon its size relative to the size of the display space and other nodes. Thus, the larger a given node is in its display space, a greater importance or significance of the corresponding data item is reflected.

The location of a data item tile within the total display space, or within a local space (or “sub space”), may generally be used to represent importance or significance as well. Many treemap displays push the location of the node (or “tile”) to one side or region of the given display space or a local space, thereby positioning the nodes representing the most important or significant data item to one area. This often creates a pattern which allows the user to focus their attention by location when trying to determine which node(s) are larger than the others as opposed to having to sort through the entire display space or local/sub space.

An additional component aimed at helping visualize the data is to provide descriptive text or symbols within the nodes of the treemap. Such descriptive indicia may assist a user in distinguishing data items which have relatively similar visual attributes as well as allow such a user to get a quick understanding of important properties of the underlying data item. Many treemap visualizations also size the indicia contained within the nodes based on the size of the tile, thus adding yet another visual indicator of importance or significance.

Due to their correlation of attributes such as color, size, text and location within a given display space, treemaps may allow a user to see a fixed pattern in the data based on some given criteria. This is meant to aid the user in ascertaining absolute and relative significance of underlying data based on the manner in which the nodes corresponding to the data are displayed. As a result, treemaps have found favor in a variety of valid uses in commercial, public and private sectors. For instance, one recent treemap development occurred in 2004 with the advent of the Newsmap. The Newsmap took the elements of the treemap and applied it to sources of news stories while applying conventional data correlation criteria and treemap visualization techniques. Thus, it is believed that the novelty and renewed enthusiasm in treemap was not being driven by the technology behind the treemap but by the content which was being displayed; namely, the interest in the news stories.

In recent times, much of the research into, and development of, treemaps has concentrated on tiling algorithms, which provide the formulas that determine how to divide and sub-divide the nodes within the overall display space and the various regions therein under the conditions applied to the underlying data. Some of the common tiling algorithms, such as Binary Tree, Mixed Treemaps, Ordered, Slice and Dice, Squarified, and Strip, are generally based on rectangular regions. Other non-rectangular tiling algorithms have also been developed such as Jigsaw, Voronoi, and Convex treemaps. These provide some unique visualization for treemaps but have not proven themselves to be more effective than the rectangular based tiling algorithms.

Despite such continued research and development, however, a problem which still exists is that once the underlying data values for a given treemap are set, the treemap display generally becomes a static visualization. While some versions of treemaps have used control devices to perform slight modifications to the node displayed, such controls have generally been limited to changes in the amount of data, changes in the number of groupings, changes to the number of categories of data, and in some cases limits to the number of data items to be displayed in the overall display space or in grouping which may define a local display space. Indeed, while there have been numerous ways to visualize data/information via treemaps, none have enabled one to visually conceptualize selected changes in emphasis to aspects of the underlying data in real time. To date treemap capability has concentrated in one form or other to visualize data to represent quality, urgency, interest, or changes without the capability to discover the relevance of the data being presented.

Thus, there remains a need for a system and method for real time visualization of variable adjustments to represented criteria in a treemap which enables the discovery of trends, patterns, and associations, while also providing functionality such as tripwire alerting and readiness and effectiveness/evaluation, through combinations of dynamic criteria weighting, importance stacking, relevance positioning, sizing, drilldown and time relationships.

### BRIEF SUMMARY OF THE INVENTION

A treemap visualization system and method are disclosed. They provide for real time visualization of variable adjustments to represented criteria in a treemap. The treemap visualization system and method are implemented on a computer system and comprise a database having a plurality of data items to be visualized, a layout module operative to formulate a treemap visualization layout with tiles based on data elements for each data item, a variable modifier module which enables the adjustment of how the data elements for each data item are weighted by the layout module when the treemap visualization layout is formulated, a stack handler module which sorts the data items into discrete levels so that a plurality of stackable tile layers can be formulated by layout module, and a monitor module for generating alerts when layout events related to the physical properties or positioning of the tiles in the treemap visualization layout.

The treemap visualization system and method thereby incorporate treemap visualization technologies for the discovery of trends, patterns, and associations, while also providing functionality such as tripwire alerting and readiness and effectiveness/evaluation. Particularly, techniques such as dynamic criteria weighting, importance stacking, relevance positioning and sizing, drill down and time relationships are used both individually and in combination to offer a novel method to visualize the relevance of the data.

The present system and method may provide an ability to vary the weight of applied criteria to treemap items over a range which can vary from no application of the criteria, to full application, to multiples of the full weight of the criteria.

The system and method described herein may permit visualization of the effect that changing the weight of criteria has on size, color, position and depth of treemap items.

The present system and method may enable discovery of trends, patterns and associations among the treemap items as criteria weights are modified.

The system and method described herein may provide alerting based on boundary conditions which get met as criteria weights change such as the exclusion of certain treemap items or other specified triggers.

The present system and method may provide an ability to couple or de-couple the dynamic weighting of criteria to specific features of the treemap display as well as between the criteria itself, thereby allowing for conditional relationships between criteria or complete independence.

The present system and method may provide for ordering of treemap items based on depth of the item versus x and y positioning.

The system and method described herein may allow overlapping and obscured treemap items within the display.

The present system and method may provide for bubbling up of important and relevant treemap items based on depth, layering or levels.

The system and method described herein may enable peeling back of layers/levels/depth to view sub-layers.

The present system and method may enable the discovery of trends, patterns and associations among treemap items based on depth/layer/level positioning.

The system and method described herein may enable the determination of depth relationships among similar or dissimilar treemap items.

The present system and method may provide for determination and modification of depth of treemap items based on dynamic criteria weighting.

The system and method described herein may provide support for user defined ordering, based on list view of user selected items based on intuition, experience, knowledge or other factors of the end user.

The present system and method may apply list view ordering to reset treemap items shown in treemap display. Such functionality applies the user defined ordering of the selected items in the list to that of the treemap display.

The system and method described herein may permit the normal drill down to view treemap item information as well as to add markings and links to other treemap items within the detailed set of information being presented.

The present system and method may reveal depth relationships among similar or even dissimilar treemap items.

The system and method described herein may provide patterns, trends and associations via drill down in one particular spot over the depth/layering of the treemap items.

The present system and method may provide layer by layer drill down capability.

The system and method described herein may enable positioning of the most relevant/important to the center or any user defined region of the treemap display.

The present system and method may provide a de-cluttering capability through layer stacking and drill down functionality.

The system and method described herein may provide an ability to dynamically modify the positioning of treemap items based on dynamic criteria weighting.

The present system and method may enable the usage of visualizing the change in treemap item color gradient as is varies over time.

The system and method described herein may provide visualization of size, position, depth and coloring (categorization) as it varies over time.

The present system and method enable visualization of the depth or ordering of treemap items as it varies over time.

The system and method described herein may enable the determination of trends, patterns and associations of treemap items as time varies.

The present system and method may provide an ability to modify criteria at given temporal locations, which can demonstrate new views of the data at the given temporal location, and visualize the effect of criteria changes would have on future or past treemap items.

The system and method described herein may provide an ability to visualize a priori and a posteriori treemap items, as temporal positioning is varied, and discover patterns, trends and associations among treemap items over time. This can be shown historically or via provided projections or estimations of future treemap item relevance/importance.

The present system and method may allow end user selection and ordering of treemap items as a separate list view which can be dynamically re-ordered.

The system and method described herein may allow for the application of a list view ordering/stacking to the treemap display.

The present system and method may provide dynamic layer extraction or re-applying extracted layers with the ability to filter treemap content to show patterns in relevance stacking.

The system and method described herein may provide an ability to leverage 3D visualization technology to view treemap items in the depth perspective while reducing the need to provide layer extraction.

### BRIEF DESCRIPTION OF THE DRAWINGS

FIG. 1A shows a screen shot of a financial treemap visualization display in accordance with the prior art showing stock tiles.

FIG. 1B shows a screen shot of a news treemap visualization display in accordance with the prior art showing story tiles.

FIG. 2 is a block diagram of the components of a treemap visualization system built in accordance with the prior art.

FIG. 3 is a block diagram of the components of a system for real time visualization of variable adjustments to represented criteria in a treemap built in accordance with the present disclosure.

FIG. 4 shows a screen shot of an output display of a treemap visualization in accordance with the present disclosure.

FIG. 5 shows the steps through which a system for real time visualization of variable adjustments to represented criteria in a treemap prepares a treemap visualization.

### DETAILED DESCRIPTION OF THE INVENTION

A treemap visualization system and method are described herein. The system and method integrate a plurality of discrete variable modifier interfaces. The system and method enable real time visualization of the impact of adjustments in emphasis of the data input values on the attributes of a treemap visualization.

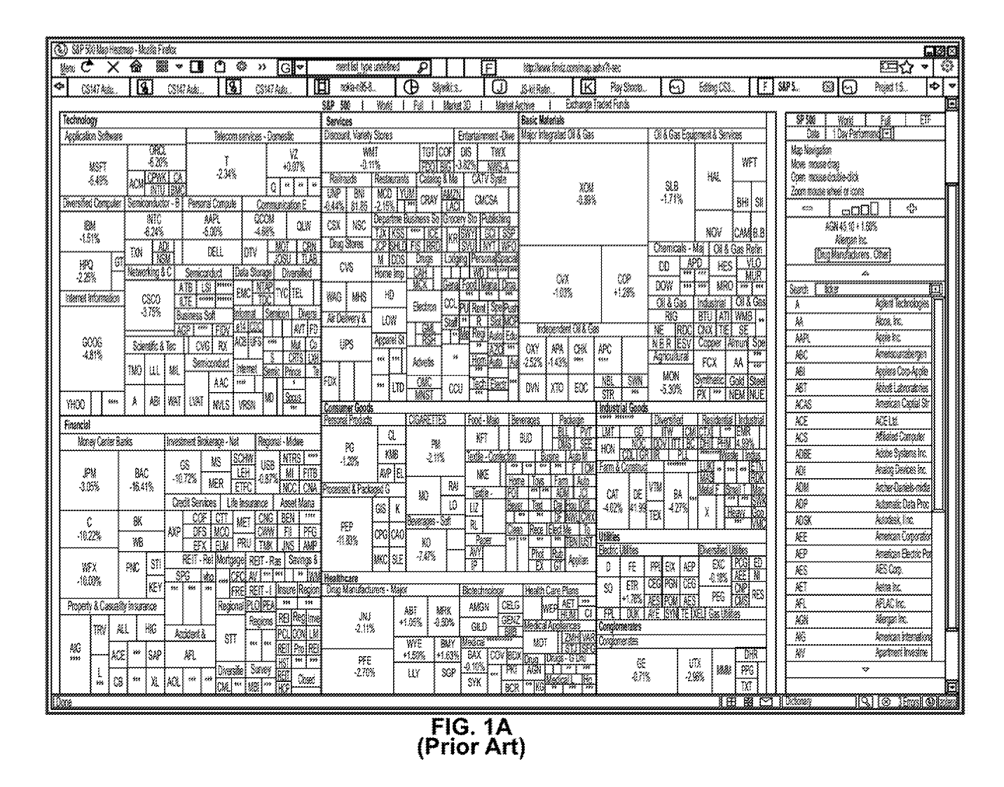

Referring now to the drawings and in particular FIG. 1A, a first example of a conventional treemap visualization display is shown having a total display space filled with a plurality of tiles which each represent a specified business entity stock value. Each of the tiles are located in the total display space, first, within a segment sub space which corresponds to a classification of the entity's primary business, and second, within a categorical local space. Each segment sub space is located in the local space which corresponds to the industry in which the sub spaces (and tiles housed therein) together may be classified. The discrete tiles, discrete sub spaces, and discrete local spaces are each relatively sized to represent a corresponding defined value. The tiles are housed and positioned in the sub space based on their size relative to the other tiles in that sub space. The sub spaces are housed and positioned in the local space based on the relative size of the sub space relative to the other sub spaces in that local space. The local spaces are housed and positioned in the total display based on their size relative to the other local spaces in the total display space. In the first example of a conventional treemap visualization display, the larger tiles/sub spaces/local spaces are biased towards the upper left corner of their respective housing space.

Each tile may also be colored to reflect a value, such as their percentage growth over a selected time interval.

Referring now to FIG. 1B, a second example of a conventional treemap visualization display is show. This display also has a total display space filled with a plurality of tiles. In the second conventional treemap visualization display, each tile represents a specified news story, and each of the tiles are located in the total display space within a categorical local space which corresponds to a specified categorical grouping. The discrete tiles and discrete local spaces are each relatively sized to represent a corresponding defined value. The tiles are housed and positioned in the local space based on the relative size of the tiles relative to the other tiles in that local space. The local spaces are housed and positioned in the total display based on their size relative to the other local spaces in the total display space. In the second example of a conventional treemap visualization display, the larger tiles/sub spaces/local spaces are biased towards the upper left corner of their respective housing space. In addition, the text in each tile is relatively sized such that the larger tiles have larger text.

In the second example of a conventional treemap visualization display, it is contemplated that each tile may also be colored to reflect a first value, such as the local space in which it is housed, and shaded to reflect a second value, such as the age of the news story.

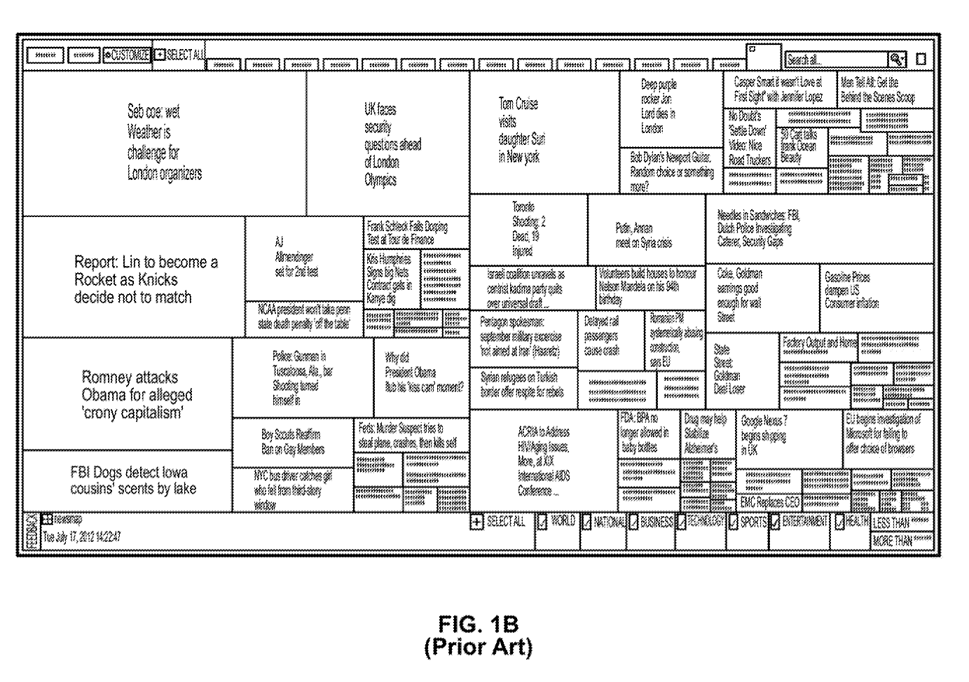

Referring now to FIG. 2, for typical treemap visualizations, a computer system 10 may be employed to take raw data in a database 20 housed on or available to the computer system 10. The computer system 10 may be employed to generate a treemap visualization through a layout module 21 embodied in software housed on or available to the computer system 10. The computer system 10 may be employed to output a treemap display on an optical output interface such as a display screen 12. It is appreciated that in such typical implementations, the layout module 21 incorporates a tiling algorithm to determine the layout of objects (i.e. tiles, sub spaces, local spaces) in the display space.

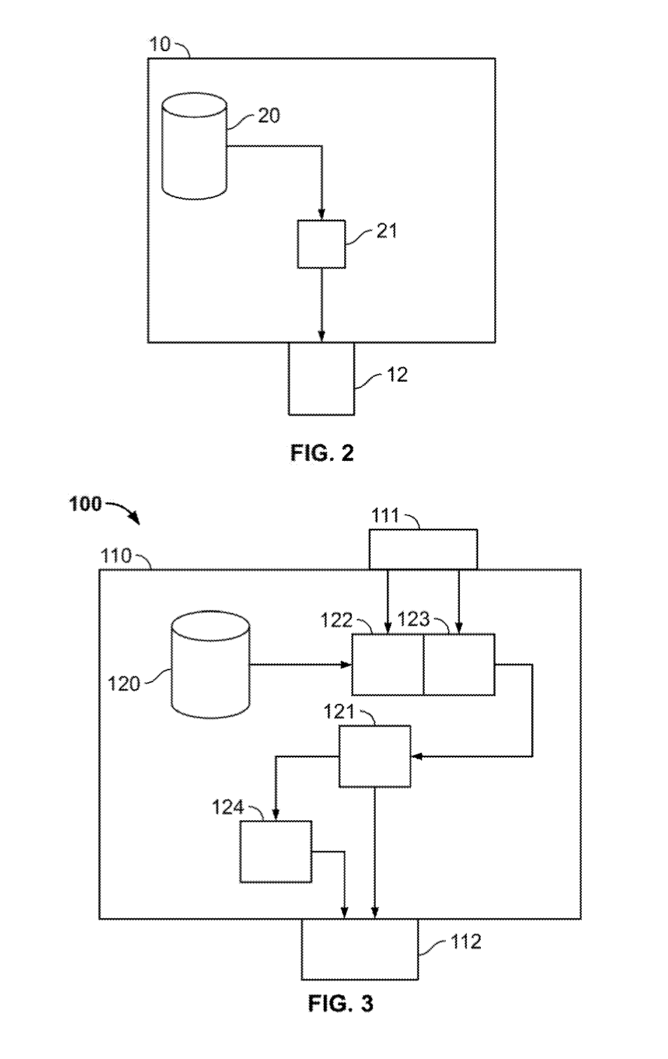

Referring now to FIG. 3, similar to typical treemap visualizations, a system is provided for real time visualization of variable adjustments to represented criteria in a treemap 100. The treemap visualization system may also be implemented on a computer system 110, which includes a processor, non-volatile memory, a user input interface 111 (such as a keyboard, mouse, or touch screen), and an optical output interface such as a display screen 112. In addition to a database 120 and layout module 121, however, a variable modifier module 122, a stack handler module 123, and a monitor module 124 are also embodied in software housed on or available to the computer system 110. In this regard, aspects of raw data from the database 120 may be modified and the elements in the raw data may be sorted by importance/relevance criteria prior to being provided to the layout module 121 where a treemap layout is determined. Moreover, changes to the treemap layout resulting from such modifications or sortings may be monitored to allow for notifications of layout events to be generated.

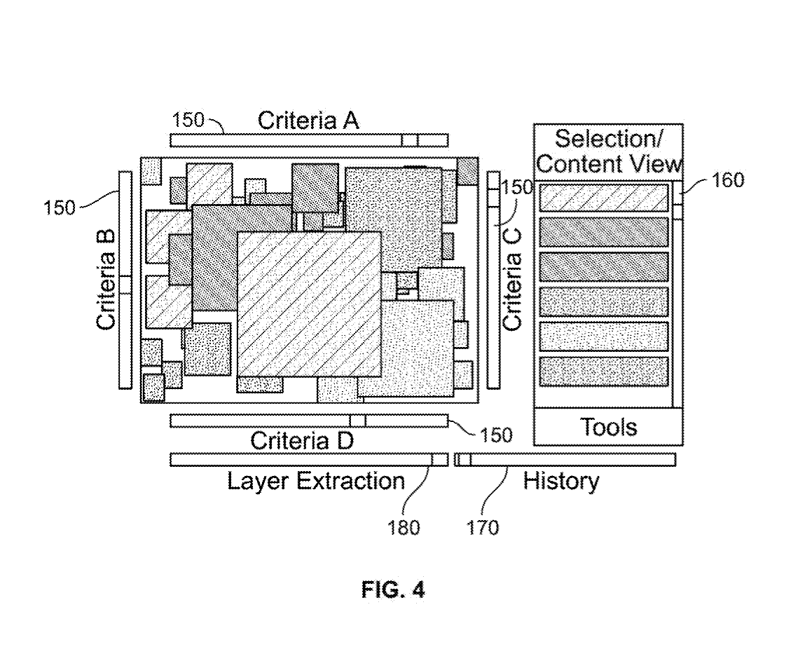

Referring now to FIGS. 3 and 4, the system for real time visualization of variable adjustments to represented criteria in a treemap 100 is operative to manipulate the visualization of tiles which reflect data items through the techniques of 1) dynamic criteria weighting, 2) importance stacking, 3) drill down, 4) relevance positioning, and 5) time/historic relationships/associations. These techniques are implemented through the layout module 121, variable modifier module 122, stack handler module 123, and monitor module 124, and together operate to enable a user to visualize the relevance of the data displayed by the treemap visualization.

### Dynamic Criteria Weighting

In a treemap visualization the variable modifier module 122 includes instructions that enable the processor of the computer system 100 to perform dynamic weighting of criteria appurtenant to the data in the database 120. The dynamic weighting of criteria is a technique to vary the value of a given criteria and/or multiple given criteria in order to visualize the effects of changes to the weight applied to the criteria or set of criteria has on the treemap layout. In this regard, by manipulating how the values for data items are calculated based on defined criteria, a user can observe changes in the treemap visualization and determine the relevance of certain values embedded in a given set of data. The illustrated embodiment of FIG. 4 shows a set of four slider bars 150, each of which is assigned to a given criteria and allow the weight applied to values under that criteria to be adjusted over a range of 0.0 to 1.0, with the value of 1.0 representing full weight being given to the associated criteria and the value of 0.0 representing no weight being given to the criteria. Through the user interface 111, a user would selectively set a weight value on a given slider bar 150, thereby causing the variable modifier module 122 to modify values for data items related with the criteria associated with the applicable slider bar. Such modified values for data items would then be used in place of the values in the raw data (or values in previously modified data) by the layout module 121, causing the layout module 121 to modify the display of the data items in the treemap visualization based on the modification of the underlying value. It is appreciated that because such modification occurs in real time, the modified display of the data items may be employed to visually indicate a new relevance of or connectivity between the data items based on the new criteria weight. Accordingly, the changing of criteria weights may dynamically vary the treemap display of the data items. This visual variance in the treemap data items is one of the means to determine data relevance, associations, patterns, and even trends.

It is contemplated that this dynamic criteria technique is advantageously utilized in combination with the other treemap modification techniques discussed herein because it may be used in association with the same to modify the results of other techniques.

In the illustrated embodiment of FIG. 4, the user interface for dynamic criteria weighting is represented by four slider bars 150. While an embodiment of four is useful for discussion purposes, it is appreciated, that the disclosure is not limited to four criteria items.

Because dynamically weighting of criteria modifies the underlying data received by the layout module 121, it is contemplated that in typical embodiments, the dynamic weighting feature has a causal effect on changes to treemap data items in terms of location, size and color.

For example, the criteria being weighed dynamically and its representative slider bar may cause tiles representing data items to be positioned nearer or farther from the edge with which the slider 150 is adjacent on the treemap display. Because tiles representing the data items in the display may change location as the weight of criteria is modified, data relevance, patterns and associations based on the weighted value of a given criteria or the change in a set of criteria, may be revealed with a spatial reference.

Similarly, as the weight of single or multiple criteria are modified, the data item's size and color may also be modified due to a variance in the value representing the same. Thus, not only may the attraction of a tile or set of tiles to a given edge provide insight to the data relationships, it can also illustrate how the data items change in color and size. Because the layout module 121 performs real time modifications to the tiles based on changes to the values for data items, the changes are visualized over the range of changes in the weights of the criteria. Moreover, while in some instances a manual change of the criteria weighting may affect a single criteria, in other instances, criteria weights may be coupled and have defined relationships such that the change in one criterion may automatically cause the change in one or more other criteria. Such linking of the criteria provides additional complexity to the nature of how data items may change due to changes in criteria, allowing for both the natural occurrence of coupled criteria items as well as when criteria items are de-coupled.

It is contemplated, however, that in some embodiments, a criteria weight is not associated with a given edge of the treemap data display. In such cases, the treemap display may have defined settings for the location of most relevant/important and least relevant/important tiles. For example, the top left corner may be fixed as the most relevant/important while the bottom right corner of the display being the least significant in relevance/importance. In the alternative, the illustrated embodiment shows a treemap display having the most relevant/important item at the center of the display.

### Importance Stacking

Enhancing flexibility of the locating of tiles by relevance/importance is the stack handler module 123. While common treemap visualizations display the data items as tiles in a specified area in a given location and of a given size, with no overlap, the stack handler module 123 employs an importance stacking technique to allow treemap data items to overlap.

In this regard, the stack handler module 123 includes instructions that enable the processor of the computer system 110 to create a plurality of discrete layers of tiles which are stackable when displayed in a treemap visualization by the layout module 121. In this regard, each time the values underlying data items are determined (or modified by the variable modifier module 122), the stack handler module 123 performs an additional sorting by a separate relevance/importance criteria (relative to the criteria used to determine tile location) and provides the data items, organized by layer, to the layout module 121 so that a separate layout can be generated for each layer. This allows the various layers of tiles to be presented in the display as a stack, with the most relevant/important items based on the current values of the data items at the top.

Because the tiles are stacked, it is understood that data items may overlap or be completely obscured by other data items. It is contemplated, however, that in some embodiments, the stack handler module 123 may be deactivated to allow the layout module 121 to fit all tiles on a single layer. It is noted that by allowing most relevant/important items to peculate to the top of the treemap visualization, an additional dimension of insight into a data item's relationships in terms of not just the location to the right, left or center but also the depth of the item is provided through the stack handler module 123.

In one embodiment, the stack handler module 123 operates along with the variable modifier module 122, allowing for real time adjustments to be made to which layer a data item may be sorted into, depending on the instant weight assigned to the criteria whose weight is being modified by the variable modifier module 122. Through such interaction, changes in the weight applied to a given criteria may bring to light additional relationships and associations with the data items as they are brought forward or back in layering depth.

In addition to enabling the layout module to generate a plurality of layers of tiles, the stack handler module 123 also enables a user to navigate through the stacked layers so that a user can also view the other data items through a layer extraction slider 180. Such functionality enables a user to then peel back layers to visually investigate the various layers or tiles as sorted by relevance/importance.

In the illustrated embodiment, layers may also be navigated through a navigation panel 160 present on the display. The navigation panel 160 provides a list based user interface item which allows a user to drag and drop items off of the treemap display onto this list display. In some embodiments, the navigation panel 160 additionally allows a user to reorder the data items on the list. In such embodiments, reordering of the list may cause corresponding adjustments to the relevance/importance stacking criteria. Advantageously, when reordering data items, a user can visually note the difference in the treemap display as items are put in to different orders in the list display. In addition, it is contemplated that the navigation panel 160 may operate to reflect the all of the tiles stacked at a given location in the display. Thus, as layers are hidden and removed from the treemap visualization, such changes are visually reflected on the list display. This effect allows the items dragged onto the list display to be display or not be displayed on the treemap visualization. In either case, the changing of the visualization of the data allows for added insight into trends, patterns, and associations of the data in the treemap.

### Drill Down

Conventional drill down techniques in a treemap visualization are often directed towards presenting a popup window or some other user interface in response to a user selection of a treemap object to provide additional information about the selected object. Thus, through conventional drill down functionality, a treemap will summarize the content of a data item as best as possible in order and to allow a user to find out more about the item.

While such drill down functionality is generally considered a necessary feature of a treemap display, in light of the real time modifications to data items which occur in accordance with the present invention, it is desirable to extend the concept to include allowing a user to drill down in to the layering and/or ordering of the data items in a treemap visualization in order to pick up on additional associations and relationships. Accordingly, the layout module 121 additionally includes instructions that enable the processor of the computer system 110 to reveal layering/ordering for data items of the same categorization (such as the same designated color), or the same size, or other factor which leads to the display of the depth and location of the target data items.

Similarly, the drill down technique, in accordance with the present disclosure, allows a user to drill down at a singular spot in the treemap display to see the items which end up at the same location, however, many have differing layering or ordering.

For example, in the illustrated embodiment in which the most relevant/important treemap items are biased into the center of the display rather to a given corner or a given edge, it is contemplated that it may be beneficial to drill down at the center to see the underlying treemap items to gain a sense of all items ranked most relevant/important at a particular layer due to its center location despite the application of other criteria which resulted in them being sorted into a lower layer on the treemap visualization display.

It is appreciated that the provision of such extended information may still be provided through a conventional interface. As such, the additional information may be provided in the form of a popup window or even a full view window which shows the entire set of information associated with the selected treemap item. Instead of merely showing information about the data item underlying a particular tile, when the drill down technique is employed to investigate layered tiles, the result can correlate and show relationships between a plurality of treemaps' data items within the full view window of the selected item. The concept is to highlight or mark related items and link them from this window so the user can open the marked related items to see the details on these. A conventional window navigation toolbar is provided in one embodiment to allow a user to always work the way back to the originally selected treemap item.

### Relevance Positioning

While most treemap visualizations incorporate relevance positioning features into their layout generation, it is contemplated that because of the availability of a plurality of layers in which tiles may be sorted, relevance positioning in each given layer is more freeform in terms of fitting everything in a separate space on a single layer. Thus, in one embodiment, the layout module 121 is operative to separate each layer drive from the most relevant or important treemap items to the center of the treemap visualization display. This could be viewed as an overall best rated treemap item for the set of criteria provided and any dynamic weighting applied to those criteria.

Significantly, the addition of layering, ordering and drill down support the concept of overlapping and obscuring while still providing the end user the capabilities to see or understand what is being overlapped or hidden. In addition, the depth positioning enabled by the importance stacking feature, as a part of the overlapping and obscuring, adds yet another dimension in providing understanding of the relationship between similar and dissimilar treemap items. And with the drill down and importance stacking features, even obscured tiles can still be analyzed in the context of the entire visualization. Furthermore, the use of sliders to extract layers from the display is like peeling back the top layer time and time again to see and understand what is underneath, both in isolation and relative to the other layers. Because the layers are presorted, layer extract occurs not in a depth but by sorted or categorized kind. A user can extract categories or kinds of treemap items one at a time, by layer, in order to visualize relationships in this manner. This facilitates a type of de-cluttering of the display or a means to hide treemap items which may be deemed not relevant for a given visualization.

### Time or History

Only in the most recent versions of conventional treemaps has a time element been added to the treemap display. This has typically been performed through color coding, with changes to the given color's gradient to illustrate a sense of age. For example, in FIG. 1B, the age of the story may be reflected by the gradient of the given color assigned to a given type of story. Generally, the brighter the color, the more recent the story is and the darker the gradient of the color, the older the news story may be. This relationship, although dynamic over time, has no effect on positioning and size and depth of a given treemap item and there is no way to see the effect as time changes. On the contrary, it is merely an instant snapshot of where things are with added gradients.

In the illustrated embodiment, the layout module 121 generates a time or history slider 170 to enable manual adjustment of the instant in time which is presently being visualized by the treemap visualization. Thus, by moving the slider 170, the location, color and size of the tiles may change based on the value of the underlying data item at whatever point in time is represented by the instant location of the slider. This also allows the user to position the slider 170 at a given location, thereby fixing the point in time, and then perform additional modifications of the data through techniques, e.g., dynamic criteria weighting, importance stacking and drill down, to examine or approximate various “what ifs,” contingencies, and conditions that have occurred or even may occur a future point in time. Accordingly, not only may a user perform a priori and a posteriori evaluation of existing data visualized by the treemap visualization, but a user may be able to estimate changes to incomplete historic data given the user's specified changes and prospective future data for the treemap visualization.

It is noted that some embodiments may still apply the gradient coloring scheme. Such embodiments, however, would still allow for a visualization of the change in position, size, depth and even color to add significant understanding to a set of data visualized by the treemap.

### List View

As discussed above, the list view enabled by the navigation panel 160 serves as a means to store and rank selected items by the end user. It provides an auxiliary, supplemental picture of the status of treemap data items based on the end user's preference, intuition, or experience and knowledge versus what the treemap system may provide in the treemap display. Because a user can order the selected items with the usual criteria of most relevance/importance at the top of the list, the list view provides a spatial interface through which a user can implement changes to the treemap display itself by using the ordering of the list and reapplying that criteria upon the treemap display. This allows the end user to visualize changes to treemap items that are currently set in the treemap display, based upon their ordering and reapplication of criteria. This may apply to positioning, size, depth and coloring. This list serves as an additional tool to either place items in a list per the end users preferences, or to apply them to the treemap display.

### 3D Visualization

In one embodiment, the layout module 121 may provide 3D visualization in addition to or in the alternative to representing the layers of tiles stacked.

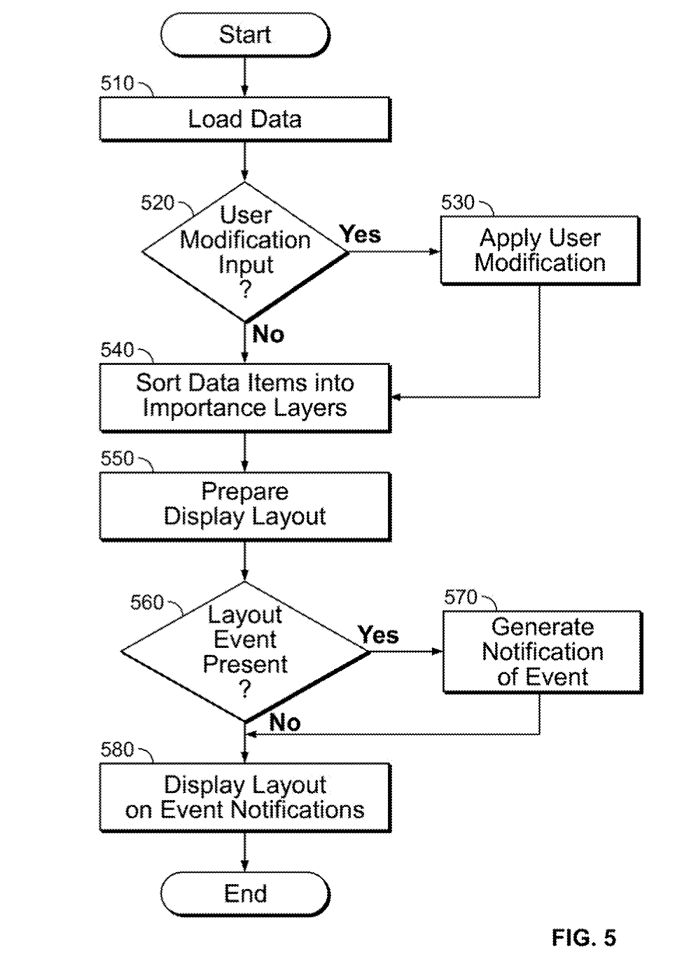

Referring now to FIG. 5, a system for real time visualization of variable adjustments to represented criteria in a treemap prepares a treemap visualization from target data. At step 510, the system loads data. At step 520, the system checks to determine whether there has been any user input that modifies some criteria of the data or some relevance/importance of the data. In typical embodiments, user input that modifies some criteria of the data or some relevance/importance of the data is received through the user input interface and passed to the variable modifier module or stack handler module.

It is contemplated that the target date may define raw data from a database or data which has been previously modified as a result of user action.

If there has been some modification, then at step 530, the values underlying the data related to the modification are recalculated in accordance with the modification, and then the data items which define the data are sorted into importance layers. If there has not been any modification, then at step 540, the data items are simply sorted into importance layers. In typical embodiments, the stack handler module performs the sorting of data items into layers and defines a stacking order for each layer.

It is contemplated that, depending on the values underlying the data items, the data items may be sorted into a single layer or into multiple layers.

Once the data items are sorted into layers, then at step 550, a display layout is separately generated for each layer. At this time, at step 560, a monitor module checks the display layout for a layout event and at step 570 generates a notification event alert in the event a layout event is present. In one embodiment, layout events include, without limitation, the disappearance of a data item type, the change in color (category or gradient) of a data item, or the unique overlap or complete separation of data items. In this regard, the monitor module provides alerts and set conditions which may impose boundary limits to the data in such a way as to alert a user to critical conditions that occur as the criteria is modified. By doing so, the monitor module provides tripwire alerting and may assist in determining the effectiveness and or readiness of a given system or sub-systems/parts or sub-parts/components or sub-components.

In the event a layout event is present, then at step 570, the generated notification event is displayed along with the generated display layouts. If no layout event is present, then at step 580, the system simply displays the generated display layouts, stacked according to the stack handler module specifications.

In an alternate embodiment, varying backend algorithms may be employed to process treemap items for size, position, depth, color, criteria weighting, relevance stacking, a priori temporal adjustments, a posteriori temporal adjustments, and modifications at a given temporal location and the manner in which it estimates changes both a priori and a posteriori predictions of treemap item state.

In another alternate embodiment, the criteria or number of criteria which is modified may vary.

In yet another alternate embodiment, overall criteria to locate and order treemap items based on combinations of the various criteria applied at edges or in general are not provided.

In another alternate embodiment, different coloring, sizing and positioning schemes may be used.

In an alternate embodiment, a list view is not provided.

In another alternate embodiment, different algorithms or processes to apply the list view to the treemap view for stacking, positioning, and coloring are utilized.

In yet another alternate embodiment, non-rectangular shapes for treemap items and the treemap display as are found in alternative shape algorithms for treemaps are incorporated.

In another alternate embodiment, there is a variance to the number and weighting criteria applied to the treemap items.

In an alternate embodiment, there is a variance to the restriction or freedom in allowance of the number of treemap items to be displayed.

In another alternate embodiment, there is a variance to the number of categories or groupings of the treemap items.

In yet another alternate embodiment, there is a variance to the use of 3D display techniques for the depth visualization of the various layers/levels/stackings of treemap items.

It will be understood that many additional changes in the details, materials, steps and arrangement of parts, which have been herein described and illustrated to explain the nature of the invention, may be made by those skilled in the art within the principle and scope of the invention as expressed in the appended claims.

What is claimed is:

1. A system for real time visualization of variable adjustments to represented criteria in a treemap, comprising:
a computer having a processor, a user input interface, and an optical output interface, wherein said processor is configured to access a database containing a plurality of data items that each have a plurality of fixed data elements associated therewith;
a layout module integral with said processor, wherein said layout module adapts the processor to generate a treemap visualization that positions within a display space a corresponding tile having physical properties for each of said plurality of data items;
wherein the physical properties of each tile and the location of each tile in the display space relate to the data elements for the data item to which the respective tile corresponds; and
a variable modifier module integral with said processor, wherein said variable modifier module adapts the processor to perform a dynamic weighting of criteria technique on the data items, thereby causing for each of said plurality of data items a modification to at least one of the physical properties and the location of the corresponding tiles.

2. The system of claim 1, wherein said dynamic weighting of criteria technique causes the processor to modify at least one of the plurality of data elements for the plurality of data items upon receiving a modification input command, thereby causing for each of said plurality of data items a modification to at least one of the physical properties and the location of the corresponding tiles.

3. The system of claim 2, additionally comprising a monitor module integral with said processor, wherein said monitor module adapts the processor to generates a notification event alert in the event a layout event is detected.

4. The system of claim 3, wherein said layout event defines a change in at least one of the physical properties and the location of at least one of the corresponding tiles.

5. A system for real time visualization of variable adjustments to represented criteria in a treemap, comprising:
a computer having a processor, a user input interface, and an optical output interface, wherein said processor is configured to access a database containing a plurality of data items that each have a plurality of fixed data elements associated therewith;
a layout module integral with said processor, wherein said layout module adapts the processor to generate a treemap visualization that positions within a display space a corresponding tile having physical properties for each of said plurality of data items;
wherein the physical properties of each tile and the location of each tile in the display space relate to the data elements for the data item to which the respective tile corresponds; and
a stack handler module integral with said processor, wherein said stack handler module adapts the processor to perform an importance stacking technique.

6. The system of claim 5, wherein said importance stacking technique causes the processor to sort the plurality of data items into a plurality of levels based on an application of a predefined depth parameter to at least one of the plurality of data elements, thereby enabling said layout module to cause the processor to arrange corresponding tiles within the display space in layers which are stacked to correspond to the sorted levels.

7. The system of claim 6, wherein the layers of corresponding tiles include tiles which overlap within the display space.

8. The system of claim 6, wherein the stack handler module additionally causes the processor to generate a layer extraction interface which, in response to a reorder input command, operates to reorder the stack of layers in the display space.

9. The system of claim 6, wherein the stack handler module additionally causes the processor to generate a navigation panel defining a user interface relating to the stack of layers in the display space.

10. The system of claim 9, additionally comprising a monitor module integral with said processor, wherein said monitor module adapts the processor to generates a notification event alert in the event a layout event is detected.

11. The system of claim 10, wherein said layout event defines the complete overlap of at least one of the corresponding tiles by another corresponding tiles.

12. The system of claim 6, additionally comprising a variable modifier module integral with said processor, wherein said variable modifier module adapts the processor to perform a dynamic weighting of criteria technique on the data items, thereby causing for each of said plurality of data items a modification to at least one of the physical properties, the location, and the layer of the corresponding tiles.

13. The system of claim 12, wherein said dynamic weighting of criteria technique causes the processor to modify at least one of the plurality of data elements for the plurality of data items upon receiving a modification input command, thereby causing for each of said plurality of data items a modification to at least one of the physical properties, the location, and the layer of the corresponding tiles.

14. The system of claim 13, additionally comprising a monitor module integral with said processor, wherein said monitor module adapts the processor to generates a notification event alert in the event a layout event is detected.

15. The system of claim 14, wherein said layout event defines a change in at least one of the physical properties, the location, and the layer of at least one of the corresponding tiles.

16. A method of real time visualization of variable adjustments to represented criteria in a treemap, comprising the steps of:
accessing by a computer having a processor, a user input interface, and an optical output interface a database containing a plurality of data items that each have a plurality of fixed data elements associated therewith;
generating by said processor a treemap visualization that positions within a display space a corresponding tile having physical properties for each of said plurality of data items, wherein the physical properties of each tile and the location of each tile in the display space relate to the data elements for the data item to which the respective tile corresponds;
sorting by said processor the plurality of data items into a plurality of levels based on an application of a predefined depth parameter to at least one of the plurality of data elements; and
arranging the corresponding tiles within the display space in layers which are stacked to correspond to the sorted levels.

17. The method of claim 16, additionally comprising the step of providing a layer extraction interface which, in response a reorder input command, operates to reorder the stack of layers in the display space.

18. The method of claim 16, additionally comprising the step of modifying by said processor at least one of the plurality of data elements for the plurality of data items upon receiving a user input, thereby causing for each of said plurality of data items a modification to at least one of the physical properties, the location, and the layer of the corresponding tiles without altering the database.

19. The system of claim 18, additionally comprising a monitor module integral with said processor, wherein said monitor module adapts the processor to generate a notification event alert in the event a layout event is detected.

20. The system of claim 19, wherein said layout event defines a change in at least one of the physical properties, the location, and the layer of at least one of the corresponding tiles.
